(19) United States
(12) Patent Application Publication
(10) Pub. No.: US 2024/0245135 A1
(43) Pub. Date: Jul. 25, 2024

(54) OPTICAL SPECTRAL DETECTOR FOR AEROSOL GENERATING DEVICE

(71) Applicant: Philip Morris Products S.A., Neuchatel (CH)

(72) Inventors: Michel BESSANT, Neuchâtel (CH); Jun Wei YIM, Colombier (CH); Jun Jie HOW, Muar (MY); Dennis Yape DELA PAZ, Singapore (SG); Yih Ming NG, Singapore (SG)

(73) Assignee: Philip Morris Products S.A., Neuchatel (CH)

(21) Appl. No.: 18/686,185

(22) PCT Filed: Aug. 31, 2022
(86) PCT No.: PCT/EP2022/074191

§ 371 Date: Feb. 23, 2024

(30) Foreign Application Priority Data
Sep. 1, 2021 (EP) 21194336.0

(51) Int. Cl. A24F 40/51; A24F 40/20; A24F 40/53; A24F 40/57

(52) U.S. Cl. CPC A24F 40/51; A24F 40/53; A24F 40/20; A24F 40/57

(57) ABSTRACT

An aerosol-generating device for generating aerosol from an aerosol-forming substrate is provided, the device including: a housing defining a cavity configured to at least partially receive the substrate; and a sensing assembly including an emitter configured to emit electromagnetic radiation into the cavity, a receiver configured to receive electromagnetic radiation from the cavity, the receiver including a sensor configured to measure at least one wavelength of the received radiation, and a shield extern to the cavity such that the receiver is between the shield and the cavity, the shield being configured to block electromagnetic radiation, first and second portions of the shield being planar, the first and the second portions being non-co-planar, an angle between a normal of respective planes of the first and the second portions being substantially the same as an angle between the receiver and the emitter, and the receiver and the emitter being non-parallel.

The present disclosure relates to an aerosol-generating device for generating aerosol from an aerosol-forming substrate. In particular, the disclosure relates to an aerosol-generating device comprising a sensing assembly.

Aerosol-generating devices configured to generate an aerosol from an aerosol-forming substrate, such as a tobacco-containing substrate, are known in the art. Many known aerosol-generating devices generate aerosol by the application of heat to the substrate by a heater assembly. The heater assembly is heated when it is supplied with power from a power supply of the aerosol-generating device. The generated aerosol can then be inhaled by a user of the device.

Often the aerosol-forming substrate is receivable in a cavity of the aerosol-generating device. The aerosol-forming substrate may be part of an aerosol-generating article, at least a portion of the aerosol-generating article being receivable in the cavity of the device to then be heated during use of the device. Because the flavours are generated and released by a controlled heating of the aerosol-forming substrate, without the combustion that takes place in lit-end cigarettes for example, aerosol-generating articles developed for use with such aerosol-generating devices are typically specifically designed for that specific device. For example, the structure of the article and the composition of the substrate will be specifically designed to provide a desirable experience for a user. Using the wrong type of aerosol-generating article, or a lit-end smoking article, may result in a poor user experience and may also damage the aerosol-generating device.

Some aerosol-generating devices can be used with a number of different types of aerosol-generating articles that each provide different user experiences. For example, the aerosol-forming substrate of different aerosol-generating articles may have a different composition and so generate a different aerosol. The aerosol-generating device may be configured to control heating for each of the aerosol-generating articles differently, in a way that is optimized for the specific type of aerosol-generating article. Using a heating control that is unsuitable for the type of aerosol-generating article may result in a poor user experience and may also damage the aerosol-generating device.

Counterfeiting of aerosol-generating articles is also a problem. Counterfeit aerosol-generating article may be of inferior quality or may not be suitable to a specific aerosol-generating device at all.

Aerosol-generating articles are often designed to be used for a predetermined number of puffs, for example between 10 and 15 puffs. If a user continues to use the aerosol-generating article after the predetermined number of puffs has expired, the quality and quantity of aerosol generated during the puff will be low which may result in a poor user experience and may also damage the aerosol-generating device. This can be because the moisture content of the aerosol-forming substrate changes during use. Applying the same heating profile to a substrate having depleted water content will result in the amount of aerosol generated be heating the substrate changing over time which is undesirable.

As well as depleting during heating of the aerosol-forming substrate by the aerosol-generating device, the moisture content of the aerosol-forming substrate will be affected by how the aerosol-generating article is stored, and for how long, as well as by inconsistencies in the process of manufacturing the substrate. Aerosol-forming substrates having unusually high or low moisture contents may require different heating control if a consistent amount of aerosol is to be generated.

It would, therefore, be desirable to provide an aerosol-generating device that is able to accurately distinguish between different types of aerosol-generating article and to identify aerosol-generating articles that are suitable or unsuitable for use with the aerosol-generating device. It would be desirable to provide such an aerosol-generating device that is low cost and simple to manufacture. Furthermore, it would be desirable to provide a sensing assembly that does not require modifications to the aerosol-generating article or the manufacture process of the aerosol-generating article. It would also be desirable to provide an aerosol-generating device that is able to monitor the quality and use state of aerosol-generating articles.

According to an aspect of the present disclosure there is provided an aerosol-generating device for generating aerosol from an aerosol-forming substrate. The aerosol-generating device may comprise a housing defining a cavity for at least partially receiving the aerosol-forming substrate. The aerosol-generating device may comprise a sensing assembly. The sensing assembly may comprise an emitter. The emitter may be configured to emit electromagnetic radiation into the cavity. The sensing assembly may further comprise a receiver. The receiver may be configured to receive electromagnetic radiation from the cavity. The receiver may comprise a sensor. The sensor may be configured to measure at least one wavelength of the received electromagnetic radiation.

An aerosol-generating device comprising the sensing assembly may advantageously be able to detect the presence and type of aerosol-generating substrate at least partially received in the cavity based on measurements of the at least one wavelength of the received electromagnetic radiation made by the sensor. The aerosol-forming substrate may be comprised in an aerosol-generating article that is at least partially received in the cavity. In use, the emitter may advantageously emit electromagnetic radiation into the cavity in which the aerosol-forming substrate is at least partially received. The electromagnetic radiation incident on the aerosol-forming substrate or the aerosol-generating article may undergo one of the following: absorption, reflection or transmission. The amount of absorption, reflection or transmission of the electromagnetic radiation at different wavelengths may depend on the chemical structure of the aerosol-forming substrate or article. Therefore, the chemical structure of the aerosol-forming substrate or article may affect the electromagnetic radiation received from the cavity by the receiver. Different aerosol-forming substrates or articles may have a different chemical structure and so may affect the electromagnetic radiation differently. Thus, the measurement of the received electromagnetic radiation may advantageously be used to determine the presence and type of aerosol-forming substrate received in the cavity.

Preferably, the sensor of the receiver is configured to measure the intensity of the at least one wavelength of electromagnetic radiation. The measurement may comprise comparing the intensity of the at least one wavelength of electromagnetic radiation with a threshold value.

Preferably, the aerosol-generating device may comprise a controller connected to the receiver. The controller may comprise a memory. Stored in the memory of the controller may be data relating known measurements of electromagnetic radiation at specific wavelengths to chemical structures of, or types of, aerosol-forming substrates. The controller may be configured to determine the type of aerosol-forming substrate received in the cavity by comparing one or more electromagnetic radiation measurements made by the sensor of the receiver at one or more wavelengths with the known measurements stored in the memory.

The aerosol-generating device may further comprise a heater assembly. The heater assembly may be configured to heat an aerosol-forming substrate received in the cavity in use. The controller may be configured to control the heater assembly. The control of the heater assembly may be based on the type of aerosol-forming substrate determined by the controller. Preferably, the controller may be configured to control the heater assembly according to a heating profile. The heating profile may be chosen or modified according to the type of aerosol-forming substrate at least partially received in the cavity.

The emitter may comprise at least one LED to emit the electromagnetic radiation.

Preferably, the emitter may be configured to emit a plurality of wavelengths of electromagnetic radiation. The emitter may comprise a plurality of LEDs, each of the plurality of LEDs being configured to emit a different wavelength of electromagnetic radiation.

The sensor of the receiver may comprise a photodiode.

The receiver may be configured to receive a plurality of wavelengths of electromagnetic radiation. In particular, the sensor of the receiver may be configured to measure a plurality of wavelengths of the received electromagnetic radiation.

In other words, the sensing assembly may be configured to perform spectroscopy on an aerosol-forming substrate received in the cavity, or on an aerosol-generating article comprising the substrate received in the cavity. The device may comprise a controller to perform spectral analysis on the measured electromagnetic radiation. Based on the spectral analysis, the controller may be configured to determine the presence of an aerosol-forming substrate in the cavity. The controller may configured to determine the type of aerosol-forming substrate in the cavity.

Herein, determining the presence and type of an aerosol-forming substrate is used interchangeably with determining the presence and type of an aerosol-generating article comprising an aerosol-forming substrate. In either case, the aerosol-generating device may advantageously be configured to determine the presence and type of the aerosol-forming substrate or article based on its chemical composition.

In one example, the electromagnetic radiation emitted by the emitter may be incident on an aerosol-forming substrate, in which case the presence or type of aerosol-forming substrate may be determined.

Alternatively, the aerosol-forming substrate may be contained in an aerosol-generating article. In that case, the electromagnetic radiation received by the receiver may be affected by the chemical structure of the aerosol-generating article, for example a wrapper or housing of the article. Different aerosol-generating articles may comprise different chemical structures, for example different wrappers or housings. This may allow for different aerosol-generating articles to be identified.

“Different aerosol-generating article” may refer to aerosol-generating articles comprising different aerosol-forming substrates.

Furthermore, a portion of the electromagnetic radiation may pass through the aerosol-generating device to the aerosol-forming substrate such that electromagnetic radiation received by the receiver may have been affected by the chemical structure of both the aerosol-generating article and substrate.

The aerosol-forming substrate may be a solid aerosol-forming substrate. Alternatively, the aerosol-forming substrate may comprise both solid and liquid components. The aerosol-forming substrate may comprise a tobacco-containing material containing volatile tobacco flavour compounds which are released from the substrate upon heating. Alternatively, the aerosol-forming substrate may comprise a non-tobacco material. The aerosol-forming substrate may further comprise an aerosol former that facilitates the formation of a dense and stable aerosol. Examples of suitable aerosol formers are glycerine and propylene glycol.

If the aerosol-forming substrate is a solid aerosol-forming substrate, the solid aerosol-forming substrate may comprise, for example, one or more of: powder, granules, pellets, shreds, spaghettis, strips or sheets containing one or more of: herb leaf, tobacco leaf, fragments of tobacco ribs, reconstituted tobacco, homogenised tobacco, extruded tobacco, cast leaf tobacco and expanded tobacco. The solid aerosol-forming substrate may be in loose form, or may be provided in a suitable container or cartridge. Optionally, the solid aerosol-forming substrate may contain additional tobacco or non-tobacco volatile flavour compounds, to be released upon heating of the substrate. The solid aerosol-forming substrate may also contain capsules that, for example, include the additional tobacco or non-tobacco volatile flavour compounds and such capsules may melt during heating of the solid aerosol-forming substrate.

As used herein, homogenised tobacco refers to material formed by agglomerating particulate tobacco. Homogenised tobacco may be in the form of a sheet. Homogenised tobacco material may have an aerosol-former content of greater than 5% on a dry weight basis. Homogenised tobacco material may alternatively have an aerosol former content of between 5% and 30% by weight on a dry weight basis. Sheets of homogenised tobacco material may be formed by agglomerating particulate tobacco obtained by grinding or otherwise combining one or both of tobacco leaf lamina and tobacco leaf stems. Alternatively, or in addition, sheets of homogenised tobacco material may comprise one or more of tobacco dust, tobacco fines and other particulate tobacco by-products formed during, for example, the treating, handling and shipping of tobacco. Sheets of homogenised tobacco material may comprise one or more intrinsic binders, that is tobacco endogenous binders, one or more extrinsic binders, that is tobacco exogenous binders, or a combination thereof to help agglomerate the particulate tobacco; alternatively, or in addition, sheets of homogenised tobacco material may comprise other additives including, but not limited to, tobacco and non-tobacco fibres, aerosol-formers, humectants, plasticisers, flavourants, fillers, aqueous and non-aqueous solvents and combinations thereof.

Optionally, the solid aerosol-forming substrate may be provided on or embedded in a thermally stable carrier. The carrier may take the form of powder, granules, pellets, shreds, spaghettis, strips or sheets. Alternatively, the carrier may be a tubular carrier having a thin layer of the solid substrate deposited on its inner surface, or on its outer surface, or on both its inner and outer surfaces. Such a tubular carrier may be formed of, for example, a paper, or paper like material, a non-woven carbon fibre mat, a low mass open mesh metallic screen, or a perforated metallic foil or any other thermally stable polymer matrix.

In a particularly preferred embodiment, the aerosol-forming substrate comprises a gathered crimpled sheet of homogenised tobacco material. As used herein, the term ‘crimped sheet’ denotes a sheet having a plurality of substantially parallel ridges or corrugations. Preferably, when the aerosol-generating article has been assembled, the substantially parallel ridges or corrugations extend along or parallel to the longitudinal axis of the aerosol-generating article. This advantageously facilitates gathering of the crimped sheet of homogenised tobacco material to form the aerosol-forming substrate. However, it will be appreciated that crimped sheets of homogenised tobacco material for inclusion in the aerosol-generating article may alternatively or in addition have a plurality of substantially parallel ridges or corrugations that are disposed at an acute or obtuse angle to the longitudinal axis of the aerosol-generating article when the aerosol-generating article has been assembled. In certain embodiments, the aerosol-forming substrate may comprise a gathered sheet of homogenised tobacco material that is substantially evenly textured over substantially its entire surface. For example, the aerosol-forming substrate may comprise a gathered crimped sheet of homogenised tobacco material comprising a plurality of substantially parallel ridges or corrugations that are substantially evenly spaced-apart across the width of the sheet.

The solid aerosol-forming substrate may be deposited on the surface of the carrier in the form of, for example, a sheet, foam, gel or slurry. The solid aerosol-forming substrate may be deposited on the entire surface of the carrier, or alternatively, may be deposited in a pattern in order to provide a non-uniform flavour delivery during use.

The heater assembly may comprise a heating element. In use, power may be supplied to the heating element, causing the heating element to heat up. The heat may then be transferred to a received aerosol-forming substrate, for example by conduction through the device housing forming the chamber.

The heating element may be a resistive heating element. The heating element may comprise an electrically resistive material. Suitable electrically resistive materials include but are not limited to: semiconductors such as doped ceramics, electrically “conductive” ceramics (such as, for example, molybdenum disilicide), carbon, graphite, metals, metal allows and composition materials made of ceramic material and a metallic material. Such composite materials may comprise doped and undoped ceramics.

In another example, the heater assembly may comprise one or more inductor coils and the heating element may comprise one or more susceptor elements.

The one or more susceptor elements may be configured to be heatable by an alternating magnetic field generated by the inductor coil or coils. In use, electrical power supplied to an inductor coil (for example, by a power source of the device) may result in the inductor coil inducing eddy currents in a susceptor element. These eddy currents, in turn, result in the susceptor element generating heat. The electrical power is supplied to the inductor coil as an alternating magnetic field. The alternating current may have any suitable frequency. The alternating current may preferably be a high frequency alternating current. The alternating current may have a frequency between 100 kilohertz (kHz) and 30 megahertz (MHz). When an aerosol-forming substrate is received in the chamber, the heat generated by the susceptor element may heat the aerosol-forming substrate to a temperature sufficient to cause aerosol to evolve from the substrate. The susceptor element may be formed of a material having an ability to absorb electromagnetic energy and convert it into heat. By way of example and without limitation, the susceptor element may be formed of a ferromagnetic material, such as a steel.

The aerosol-generating device may comprise a power supply which may be configured to supply current to the resistive heating element.

The heating element may comprise a substrate layer of flexible material. The substrate layer may comprise a thermally stable polymer, preferably polyimide.

The heating element may be arranged on the substrate layer. The heating element may contain wire connections configured for being connected with a controller of the aerosol-generating device. The heating element may comprise heating tracks arranged on the substrate layer. The heating tracks may comprise a thermally conductive material, preferably a metal such as stainless steel. The heating tracks may be electrically connected to said wire connections.

The heating element may take other forms. For example, a metallic grid or grids, a flexible printed circuit board, a molded interconnect device (MID), ceramic heater, flexible carbon fibre heater or may be formed using a coating technique such as plasma vapour deposition, on a suitably shaped substrate.

The cavity may comprise an opening at a first end through which the aerosol-forming substrate may be receivable. The cavity may be configured to receive the aerosol-forming substrate along a longitudinal axis.

The emitter and receiver may be parallel to the longitudinal axis.

The cavity may comprise a second end opposite to the first end. The emitter and receiver may be positioned so as to emit and receive electromagnetic radiation to and from the second end of the cavity, respectively.

Alternatively, the emitter and receiver may be perpendicular to the longitudinal axis. The emitter and receiver may be positioned so as to emit and receive electromagnetic radiation to and from the cavity perpendicularly to the longitudinal axis. The emitter and receiver may be positioned so as to emit and receive electromagnetic radiation to and from the cavity at a region between the first and second end of the cavity. The emitter may be positioned outside of the cavity. The receiver may be positioned outside of the cavity.

According to a another aspect of the disclosure there is a provided an aerosol-generating device according to the previous aspect wherein the sensing assembly further comprises a shield. The shield may be positioned externally to the cavity. The shield may be positioned such that the receiver is between the shield and the cavity. The shield may be configured to block electromagnetic radiation.

The position of the shield may advantageously mean that electromagnetic radiation external to the aerosol-generating device is blocked by the shield. This may mean that electromagnetic radiation external to the aerosol-generating device is blocked from reaching the receiver. The external electromagnetic radiation might otherwise be received by the receiver and so be picked up as noise. Thus, the shield may advantageously improve the accuracy of the sensing assembly be reducing noise. This may improve the signal to noise ratio of measurements from sensor of the receiver.

One source of external electromagnetic radiation may be from a user of the aerosol-generating device. For example, the hand of a user may produce a parasitic capacitance effect on the order of pico-Farads which, without the shield, might be detected by the sensor of the receiver as noise.

As used herein, the shield “blocking” electromagnetic radiation may mean that the shield prevents external electromagnetic radiation from passing through to the receiver. The shield may reduce the intensity of the externally generated electromagnetic radiation at the receiver by at least 90%, preferably by at least 95%, even more preferably by at least 99%. The shield may be effective at reducing the intensity of electromagnetic radiation between the infrared range and the ultraviolet range. Preferably the shield may be effective at reducing the intensity of electromagnetic radiation having a wavelength between 1 nanometre and 100,000 nanometres, preferably between 200 nanometres and 30,000 nanometres, even more preferably between 200 nanometres and 15,000 nanometres. The shield may reduce the intensity of the externally generated electromagnetic radiation by absorption or reflection of the radiation.

The shield may comprise an electrically conductive material. The shield may consist of an electrically conductive material. The electrically conductive material may have an electrical conductivity of at least 1×10⁶ Siemens per metre, preferably at least 1×10⁷ Siemens per metre, even more preferably at least 5×10⁷ Siemens per metre.

The shield may comprise a thermally conductive material. The shield may consist of a thermally conductive material. This may be particularly advantageous when the aerosol-generating device further comprises a heater assembly configured to heat an aerosol-forming substrate received in the cavity in use. A shield comprising a thermally conductive material may advantageously dissipate heat generated by the heater assembly away from the receiver. The receiver may be particularly sensitive to heating and may be damaged by excessive heating. The shield comprising the thermally conductive material may advantageously prevent the receiver from overheating during use of the aerosol-generating device. The shield may be configured to prevent the receiver from exceeding 115 degrees Celsius during use of the aerosol-generating device.

The thermally conductive material may have a thermal conductivity of at least 10 Watts per metre-Kelvin, preferably at least 80 Watts per metre-Kelvin, preferably at least 100 Watts per metre-Kelvin, even more preferably at least 150 Watts per metre-Kelvin.

The shield may comprise a metal. Preferably, the shield may comprise at least one of aluminium and stainless steel.

The shield may have a thickness of between 0.1 and 3 millimetres. Preferably, the shield may have a thickness of 0.2 millimeters. Such a thickness may advantageously be high enough to ensure that the shield blocks external electromagnetic radiation sufficiently.

The shield may be sized and positioned such that the emitter is between the shield and the cavity. This may advantageously ensure that external electromagnetic radiation does not enter the cavity through the emitter. Such a shield may also advantageously dissipate heat away from the emitter.

The shield may have a width of between 1 and 10 millimetres, more preferably between 2 and 4 millimetres, even more preferably about 3 millimetres. The shield may have a length of between 10 and 30 millimetres, more preferably between 15 and 25 millimetres, even more preferably about 22 millimetres.

The emitter and the receiver may be parallel to one another. In other words, the angle between the emitter and the receiver may be about 0 degrees.

Where the angle between the emitter and the receiver is referred to herein (including terms such as parallel and perpendicular), the angle is that between the central optical axis of the emitter and the central optical axis of the receiver. This may be the same as the angle defined between the surface of an aerosol-forming substrate or article at least partially received in the cavity and the emitter and receiver.

The emitter and receiver may be next to one another. In this way, the emitter and the receiver may advantageously be provided on the same chip. This may advantageously reduce the complexity of the sensing assembly.

The emitter may be positioned on top of the receiver. The sensing assembly may comprise the emitter between the shield and the receiver.

Alternatively, the receiver and the emitter may be non-parallel. The angle between the receiver and the emitter may be between 20 and 120 degrees, preferably between 60 and 100 degrees, even more preferably 70 and 90 degrees. Most preferably, the angle between the receiver and the emitter may be about 80 degrees. Such angles may be particularly advantageous when the aerosol-forming substrate is contained in a rod shaped aerosol-generating article and the electromagnetic radiation is incident on the article perpendicular to the cylindrical axis of the rod.

At least a first portion of the shield may be planar. The receiver may be positioned between the first portion of the shield and the cavity. Both the receiver and the emitter may be positioned between the first portion of the shield and the cavity. This may be the case, for example, when the emitter is on top of the receiver.

A second portion of the shield may be planar. The first and second portions of the shield may be non-co-planar. The receiver may be positioned between the first portion of the shield and the cavity. The emitter may be positioned between the second portion of the shield and the cavity.

The angle between the normal of the plane of the first portion and the normal of the plane of the second portion may be substantially the same as the angle between the receiver and the emitter when the receiver and the emitter are non-parallel. In other words, the angle between the normal of the plane of the first portion and the normal of the plane of the second portion may be between 20 and 120 degrees, preferably between 60 and 100 degrees, even more preferably 70 and 90 degrees. Most preferably, the angle may be about 80 degrees.

The sensing assembly may further comprise a substrate. The substrate may comprise a first side onto which at least one of the emitter and the receiver are attached. The substrate may comprise a second side, opposite the first side, onto which the shield is attached. This may advantageously be a straightforward arrangement that is simple to manufacture. The substrate may be a Printed Circuit Board (PCB). The substrate may comprise more than one PCB. The substrate may comprise or consist of one or more flexible PCBs.

The shield may comprise at least one clip. The shield may comprise a first clip at a first end and a second clip at a second end, the first end being at an opposite end of the shield to the second end. The one or more clips may be configured to connect the clip to the second side of the substrate. The one or more clips may advantageously provide a simple and low cost means of attaching the shield onto the substrate. Attaching the shield on to the substrate in this way may advantageously ensure that the sensing assembly is simple and low cost to manufacture.

The shield may be connected to a ground contact of the aerosol-generating device. The ground contact may be on the substrate. The ground contact may be on the PCB if the substrate comprises a PCB. The at least one clip of the shield may be in contact with the ground contact. Connecting the shield to a ground contact may allow the shield to provide good shielding.

The shield may be integrally formed. This may include the at least one clips.

According to a another aspect of the disclosure there is provided an aerosol-generating device according to either of the previous aspects wherein the sensor assembly further comprises a lens. The lens may be configured to focus electromagnetic radiation received from the cavity on to the sensor of the receiver. The sensor assembly may comprise more than one lens, each of the one or more lenses being configured to focus electromagnetic radiation received from the cavity on to the sensor of the receiver. The one or more lenses may advantageously increase the amount of electromagnetic radiation received by the receiver. This may advantageously increase the signal to noise ratio of the sensing assembly and so improve the accuracy of the sensing assembly at detecting the presence and type of aerosol-forming substrate at least partially received in the cavity.

The larger the surface area of the lens is relative to a surface area of a part of the sensor of the receiver that is sensitive to electromagnetic radiation, the greater the amount of electromagnetic radiation that will be received by the sensor. The surface area of the lens may be at least ten times, preferably at least twenty times, even more preferably at least thirty times greater than the surface area of a part of the sensor of the receiver that is sensitive to electromagnetic radiation.

The lens may comprise an absorption material. The absorption material may be configured to substantially block wavelengths of electromagnetic radiation that fall outside a range of wavelengths. The absorption material may be transparent to electromagnetic radiation having a wavelength that falls inside a range of wavelengths. In this way, the absorption material may advantageously act as a filter, allowing wavelengths of interest to pass through the lens and blocking selected wavelengths. The absorption material may, therefore, reduce noise and improve the accuracy of the sensing assembly.

The range of wavelengths of interest, referred to above, may correspond to wavelengths of electromagnetic radiation which are known to be particularly affected by the chemical structure of the aerosol-forming substrate or aerosol-generating article. The absorption material may be configured to substantially block wavelengths of electromagnetic radiation less than 200 nanometres, preferably less than 950 nanometres, even more preferably less than 1350 nanometres. The absorption material may be configured to substantially block wavelength of electromagnetic radiation greater than 30,000 nanometres, preferably 15,000 nanometres, preferably greater than 2000 nanometres, even more preferably greater than 1400 nanometres.

The absorption material may effectively act as a band pass filter, substantially blocking wavelengths of electromagnetic radiation above an upper limit and below a lower limit. These limits may be as above. In other words, the lower limit may be less than 200 nanometres, preferably less than 950 nanometres, even more preferably less than 1350 nanometres. The upper limit may be greater than 30,000 nanometres, preferably greater than 15,000 nanometres, preferably greater than 2000 nanometres, even more preferably greater than 1400 nanometres.

As explained in more detail with respect to a later aspect of the invention, the chemical structure of interest of the aerosol-forming substrate may relate to the wetness or water content of the substrate. Different type of aerosol-forming substrate may have a different water content. The water content may change depending on the amount the aerosol-forming substrate has been used, on how it was stored and on any manufacturing inconsistencies. So, it may be particularly advantageous for the aerosol-generating device to be configured to measure the water content of the substrate using the measurements by the sensor of the receiver to determine characteristics of the substrate. The above ranges of electromagnetic radiation that are not blocked by the absorption material may include a range of wavelengths that is particularly affected by the water content of the substrate.

As with the shield, the absorption material blocking electromagnetic radiation may mean that the absorption material reduces the intensity of the externally generated electromagnetic radiation at the receiver by at least 90%, preferably by at least 95%, even more preferably by at least 99% for the wavelengths that are blocked.

As used herein, transparency to certain wavelengths of electromagnetic radiation, in the context of the transparent portion or otherwise, means that at least 90%, preferably at least 95%, even more preferably at least 99% of the electromagnetic radiation at that wavelength can pass through the first or second portion without being absorbed.

A main body of the lens may comprise the absorption material. Alternatively, the lens may comprise the absorption material as a coating.

The absorption material may comprise at least one of Cadmium Telluride, Chalcogenide Glass or Zinc Selenide.

A combination of the shield described above and the lens may be particularly advantageous, particularly when the lens comprises the absorption material. Both the shield and the lens comprising the absorption material are advantageously configured to block unwanted electromagnetic radiation from reaching the sensor of the receiver. In particular, wavelengths of electromagnetic radiation outside of a range of wavelengths that is particularly affected by the chemical structure of interest of the aerosol-forming substrate may be blocked from reaching the sensor of the receiver. This may advantageously reduce noise at the receiver and so improve the accuracy of the sensor assembly.

According to another aspect of the disclosure there is provided an aerosol-generating device according to any one of the previous aspects, wherein the sensing assembly further comprises amplification electronics.

The amplification electronics may be connected to the receiver. The amplification electronics may be configured to amplify signals generated by the sensor of the receiver.

The amplification electronics may be analogue amplification electronics. The aerosol-generating device may further comprise electronics configured to convert the analogue output of the amplification electronics into a digital signal. This may be advantageous when the device comprises a controller that operates on digital signals.

Preferably, the amplification electronics are connected directly to the receiver. More preferably, when the sensing assembly comprises a printed circuit board (PCB) comprising the receiver, the amplification electronics are provided as part of the same printed circuit board. Even more preferably, the amplification electronics and the receiver are provided as a single component. In each case, the noise introduced to a signal generated by the receiver before the signal is amplified may advantageously be reduced.

Minimizing the amount of noise that is introduced to the signal generated by the sensor of the receiver before the signal reaches the amplification electronics may be advantageous. This is because the signal generated by the sensor may be relatively small, for example the signal may have a current between 50 and 200 nano-Amperes. Without minimizing the number of electrical connection and components between the sensor of the receiver and the amplification electronics, the signal generated by the sensor may be lost in noise caused by those connections. The noise would then be significantly amplified by the amplification electronics.

The amplification electronics may be configured to amplify a voltage of a signal generated by the sensor of the receiver by at least a factor of at least one hundred thousand, preferably by at least a factor of one million, even more preferably by a factor of between one million and one hundred million, even more preferably by a factor between ten and thirty million, most preferably about twenty five million.

A combination of the amplification electronics with at least one of the shield described above and the lens described above may be particularly advantageous, particularly when the amplification electronics are provided in a way so as to minimize the amount of noise introduced to the signal from the sensor of the receiver and when, if combined with the lens, the lens comprises the absorption material. This may be because said amplification electronics, the shield and the lens comprising the absorption material all reduce the noise detected by or generated by the sensing assembly. A reduction in noise may advantageously result in the sensing assembly having improved accuracy. Furthermore, when the lens is combined with the amplification electronics the amplification factor can advantageously be lower to achieve the same output voltage. This is because the lens may increase the signal strength generated at the receiver and so needs less amplification. Reducing the amplification factor may advantageously reduce the amount that noise is amplified.

According to another aspect of the disclosure there is provided an aerosol-generating device according to any of the previous aspects, wherein a first portion of the housing defining the cavity is transparent to at least one wavelength of the electromagnetic radiation emitted by the emitter. The first portion of the housing may preferably be transparent to all of the wavelengths of the electromagnetic radiation emitted by the emitter. The emitter may be configured to emit the electromagnetic radiation into the cavity through the transparent portion.

The first portion of the housing may separate the emitter from the cavity. Therefore, the first portion of the housing may protect the emitter from debris and dirt that may accumulate in the cavity. In particular, the emitter may be protected from residue from the aerosol-forming substrate that may accumulate during use of the aerosol-generating device. The first portion may be also advantageously be easy to clean such that the device can simply be maintained.

An airflow path may be defined through the aerosol-generating device from an air inlet to an air outlet. The airflow path may pass through the cavity. The emitter may be separated from air flowing through the airflow path by the transparent first portion of the housing. The air may carry debris or dirt. Therefore, the first portion may protect the emitter from air passing through the airflow path.

The first portion of the housing may be sized and positioned to correspond to the viewing angle of the emitter. This may advantageously ensure that substantially all of the electromagnetic radiation emitted by the emitter in use passes into the cavity.

A second portion of the housing defining the cavity may be transparent to at least one wavelength of electromagnetic radiation received by the receiver. The receiver may be configured to receive the electromagnetic radiation from the cavity through the second transparent portion.

The second portion of the housing may have corresponding features and advantages as described with respect to the first portion, only with respect to the receiver rather than with respect to the emitter.

The provision of the first and second portion of the housing may advantageously increase the lifetime of the sensing assembly. Without the first and second portions of the housing, the sensing assembly may deteriorate over time as it becomes coated with dirt, debris and substrate residue. In a deteriorated sensing assembly, the amount of electromagnetic radiation entering the cavity from the emitter or received by the receiver from the cavity might be reduced which would reduce the accuracy and sensitivity of the sensing assembly.

A combination of at least one of the first and second portions of the housing, as described above, in combination with at least one of the shield described above, the lens described above or the amplification electronics described above may be particularly advantageous. Each of these features provides advantages relating to noise reduction and improved accuracy of the sensing assembly. An aerosol-generating device comprising a combination of these features may advantageously have a yet more accurate sensing assembly and one in which the accuracy does not deteriorate over time.

According to another aspect of the disclosure there is provided an aerosol-generating device according to any one of the previous aspects, wherein the sensing assembly further comprises a substrate having a first side onto which at least one of the emitter and receiver are attached. Both the emitter and the receiver may be attached to the first side.

The substrate may comprise a flexible portion. The flexible portion may be configured so that the emitter is moveable relative to the receiver by bending the flexible portion. As described above, the angle between the receiver may preferably be between 20 and 120 degrees, preferably between 60 and 100 degrees, even more preferably 70 and 90 degrees. Most preferably, the angle between the receiver and the emitter may be about 80 degrees. A substrate comprising a flexible portion may advantageously allow the angle between the emitter and the receiver to be controlled in a simple way during the manufacturing process. Using a substrate comprising a flexible portion may advantageously remove the need for the substrate to pre-moulded to a desired shape. It may be possible to modify the angle between the emitter and receiver during or after the manufacture of the aerosol-forming device.

The substrate may be bent such that the emitter is adjacent a different portion of the cavity to the receiver and such that the angle between the central optical axis of the emitter and receiver is between 20 degrees and 120 degrees, preferably between 60 and 100 degrees, even more preferably 70 and 90 degrees. Most preferably, the angle between the receiver and the emitter may be about 80 degrees.

The substrate may comprise a first portion comprising the emitter. The substrate may comprise a second portion comprising the receiver. The substrate may comprise a third portion between the first and second portion. At least the third portion may be flexible such that the first portion is moveable relative to the second portion. This may allow the angle between the emitter and the receiver to be controlled, as described above.

Preferably, the first portion of the substrate may be rigid. The second portion of the substrate may be rigid. In this way, the flexible third portion acts as a hinge between the rigid first and second portions.

Preferably, the third portion of the substrate may be opaque to wavelengths of electromagnetic radiation emitted by the emitter. This may advantageously ensure that electromagnetic radiation emitted by the emitter is not directly received by the receiver before being reflected or absorbed and emitted by the aerosol-forming substrate received in the cavity.

The substrate may comprise one or more PCBs. The substrate may consist of one or more flexible PCBs. At least the third portion of the substrate may comprise or consist of a flexible PCB.

Preferably, the first and second portions of the substrate may comprise a rigid PCB and the third portion may comprise a flexible PCB.

A combination of the substrate in combination with at least one of the shield described above, the lens described above, the amplification described above and the transparent portion described above may be particularly advantageous.

A particularly preferable combination may be the substrate comprising a flexible portion, as described above, with the shield as described above when the shield comprises first and second planar portions, the second portion being planar in a plane that is different to the first portion. This is because the shield may advantageously hold the substrate so that the flexible portion is bent at a desired angle.

Preferably, the shield may be attached to a second side of the substrate opposite to the first side. The shield may be rigid.

The first portion of the shield may be attached to the first portion of the substrate. The second portion of the shield may be attached to the second portion of the substrate.

This arrangement may allow for a simple manufacture process. Advantageously, the act of attaching the shield to the substrate may hold the substrate at a desired angle.

Preferably, and as described above, the shield may comprise at least one clip. This clip may advantageously provide a simple and low cost means of attaching the shield onto the substrate, further simplifying the manufacturing process.

Preferably, the shield may comprise two clips. The first clip may attach the first portion of the shield to the first portion of the substrate. The second clip may attach the second portion of the shield to the second portion of the substrate.

According to another aspect of the disclosure there is provided an aerosol-generating device according to any one of the previous aspects further comprising a controller configured to receive signals from the receiver, wherein the controller is configured to determine material properties of the aerosol-forming substrate at least partially received in the cavity, or an aerosol-generating article comprising the aerosol-forming substrate, based on a measured intensity of the electromagnetic radiation received at the receiver.

Preferably, the controller may be configured to perform spectral analysis of the measured intensity of the electromagnetic radiation to determine material properties of the aerosol-forming substrate or an aerosol-generating article comprising the aerosol-forming substrate. Based on the determined material properties, the controller may be configured to determine the type of aerosol-forming substrate at least partially received in the cavity. The controller being configured to determine material properties of the aerosol-forming substrate may advantageously means that the type of aerosol-forming substrate can be determined directly based on inherent material properties of the aerosol-forming substrate. There is no need for the aerosol-forming substrate, or for an aerosol-generating article comprising the aerosol-forming substrate, to comprise a printed barcode, taggant or other indicia of the type of the type of substrate.

If the controller is configured to determine a material property of an aerosol-generating article comprising the aerosol-forming substrate, the material property may be a material property of a wrapper of the aerosol-generating article.

Preferably, the material property determined by the controller may be a material property of the aerosol-forming substrate. The material property determined by the controller may be a chemical property of the aerosol-forming substrate. The material property may be the presence or amount of a chemical component of the aerosol-forming substrate. When the aerosol-forming substrate comprises tobacco, the material property may relate to the tobacco content of the aerosol-forming substrate or some other chemical property of tobacco.

Preferably, the material property determined by the controller may be the wetness or water content of the aerosol-forming substrate. The controller may be configured to determine a value related to the water content of an aerosol-forming substrate received in the cavity based on the measured intensity of the electromagnetic radiation received at the receiver.

Based on the determined value related to water content, the controller may be configured to determine the type of aerosol-forming substrate received in the cavity. Different types of aerosol-forming substrate may have a different water content to one another. Aerosol-forming substrates typically comprise an aerosol former such as glycerine. The amount or type of aerosol former present in the aerosol-forming substrate may determine its wetness. So, the controller may advantageously be configured to identify aerosol-forming substrates comprising different amounts or types of aerosol former based on the determined water content in the aerosol-forming substrate.

The device may further comprise a heating assembly for heating the aerosol-forming substrate. The heating assembly may be controller by the controller. The controller may be configured to control the heating assembly according to a heating profile selected based on the determined type of aerosol-forming substrate.

The controller may be configured to determine the value related to the water content of an aerosol-forming substrate received in the cavity repeatedly during use of the aerosol-generating device. Preferably, the controller may be configured to modify a heating profile based on changes in the determined water content of the aerosol-forming substrate. The changes in determined water content may be relative to an expected water content for the determined type aerosol-forming substrate. Alternatively or additionally the changes in determined water content may be changes in the determined water content over time. For example, the changes in determined water content may be changes in the determined water content during a puff or between puffs.

The water content of the aerosol-forming substrate may reduce over time. The reduction in water content may be as a result of heating of the aerosol-forming substrate by the aerosol-generating device in use. The reduction in water content may alternatively or additionally be as a result of the aerosol-forming substrate drying out in storage, particularly if the aerosol-forming substrate is stored incorrectly. As the wetness of the aerosol-forming substrate changes, different heating profiles for heating the substrate may be required to generate the same amount of aerosol. The modification of the heating profile based on changes in the determined water content may advantageously provide a consistent amount of aerosol may advantageously be generated. For example, the maximum temperature reached during heating may be increased as the water content decreases which may advantageously account for a lower quantity of aerosol former in the aerosol-forming substrate when there is reduced wetness.

The controller may be configured to stop heating of the aerosol-forming substrate by the heater assembly if the value related to the water content of the aerosol-forming substrate falls below a predetermined value.

The emitter may be configured to emit electromagnetic radiation having a wavelength of between 1100 nanometres and 1500 nanometres. Preferably the emitter may be configured to emit electromagnetic radiation having a wavelength of between 1350 nanometres and 1400 nanometres.

The receiver may be configured to receive electromagnetic radiation having a wavelength of between 1100 nanometres and 1500 nanometres. Preferably the receiver may be configured to receive electromagnetic radiation having a wavelength of between 1350 nanometres and 1400 nanometres.

Water is particularly effective at absorbing electromagnetic radiation having a wavelength between 1100 nanometres and 1500 nanometres, and in particular between 1350 nanometres and 1400 nanometres. Thus, it may be advantageous for the emitter and receiver to emit and receive such wavelengths of electromagnetic radiation when the material property of interest of the aerosol-forming substrate is wetness or water content.

A combination of the controller configured to determine material properties of the aerosol-forming substrate at least partially received in the cavity based on a measured intensity of the electromagnetic radiation received at the substrate with at least one of the shield described above, the lens described above, the amplification described above, the transparent portion described above or the flexible substrate described above may be particularly advantageous.

For the material properties of the aerosol-forming substrate to be accurately determined based on a measured intensity of the electromagnetic radiation receiver, the signals received at the receiver may preferably have a high signal to noise ratio. At least the shield, lens, amplification electronics and the transparent portion are features which may increase the signal generated by the receiver or reduce the noise associated with said signal.

According to another aspect of the disclosure there is provided a sensing assembly for an aerosol-generating device for generating aerosol from an aerosol-forming substrate. The aerosol-generating device may comprise a housing. The housing may define a cavity. The cavity may be for at least partially receiving the aerosol-forming substrate.

The sensing assembly may comprise an emitter for emitting electromagnetic radiation into the cavity of the aerosol-generating device. The sensing assembly may comprise a receiver for receiving electromagnetic radiation from the cavity of the aerosol-generating device. The receiver may comprise a sensor. The sensor may be configured to measure at least one wavelength of the received electromagnetic radiation.

The sensing assembly may comprise any of the features described in relation to any one of the previous aspects of the disclosure.

Preferably, the sensing assembly may comprise a shield. The shield may be external to the receiver such that receiver can be positioned between the shield and the cavity of the aerosol-device device. The shield may be configured to absorb electromagnetic radiation.

Alternatively or additionally, the sensing assembly may comprise a lens. The lens may be configured to focus electromagnetic radiation received from the cavity on to the sensor of the receiver. The lens may comprise an absorption material. The absorption material may be configured to substantially block wavelengths of electromagnetic radiation having a wavelength less than 200 nanometres, preferably less than 950 nanometres, even more preferably less than 1350 nanometres. The absorption material may be configured to substantially block wavelength of electromagnetic radiation having a wavelength greater than 30,000 nanometres, preferably greater than 15,000 nanometres, preferably greater than 2000 nanometres, even more preferably greater than 1400 nanometres. The absorption material may effectively act as a band pass filter, substantially blocking wavelengths of electromagnetic radiation above an upper limit and below a lower limit. These limits may be as above. In other words, the lower limit may be less than 200 nanometres, preferably less than 950 nanometres, even more preferably less than 1350 nanometres. The upper limit may be greater than 30,000 nanometres, greater than 15,000 nanometres, preferably greater than 2000 nanometres, even more preferably greater than 1400 nanometres.

Alternatively or additionally, the sensing assembly may comprise amplification electronics. The amplification electronics may be connected to the receiver. The amplification electronics may be configured to amplify signals generated by the sensor of the receiver. Preferably, the amplification electronics are connected directly to the receiver. More preferably, when the sensing assembly comprises a printed circuit board comprising the receiver, the amplification electronics are provided as part of the same printed circuit board. Even more preferably, the amplification electronics and the receiver are provided as a single component.

Alternatively or additionally, the sensing assembly may further comprise a substrate having a first side onto which at least one of the emitter and receiver are attached. Both the emitter and the receiver may be attached to the first side. The substrate may be comprise a flexible portion as described above.

Alternatively or additionally, the sensing assembly may be configured to be used with an aerosol-generating device according to any one of the previous aspects.

In particular, the sensing assembly may be configured to be used with an aerosol-generating device wherein a first portion of the housing defining the cavity is transparent to at least some of the wavelengths of the electromagnetic radiation emitted by the emitter. The emitter may be configured to emit the electromagnetic radiation into the cavity through the transparent portion. A second portion of the housing defining the cavity may be transparent to at least some of the wavelengths of the electromagnetic radiation received by the receiver. The receiver may be configured to receive the electromagnetic radiation from the cavity through the second transparent portion.

The sensing assembly may be configured to be used with an aerosol-generating device comprising a controller as described above.

The invention is defined in the claims. However, below there is provided a non-exhaustive list of non-limiting examples. Any one or more of the features of these examples may be combined with any one or more features of another example, embodiment, or aspect described herein.

EX1. An aerosol-generating device for generating aerosol from an aerosol-forming substrate, the aerosol-generating device comprising:
a housing defining a cavity for at least partially receiving the aerosol-forming substrate; and
a sensing assembly comprising:
an emitter configured to emit electromagnetic radiation into the cavity;
a receiver configured to receive electromagnetic radiation from the cavity, the receiver comprising a sensor configured to measure at least one wavelength of the received electromagnetic radiation.

EX2. An aerosol-generating device according to example EX1, wherein the aerosol-forming substrate is comprised in an aerosol-generating article that is at least partially receivable in the cavity.

EX3. An aerosol-generating device according to example EX1 or EX2, wherein the sensor of the receiver is configured to measure the intensity of the at least one wavelength of electromagnetic radiation.

EX4. An aerosol-generating device according to example EX3, wherein the measurement comprises comparing the intensity of the at least one wavelength of electromagnetic radiation with a threshold value.

EX5. An aerosol-generating device according to according to any one of the preceding examples, wherein the aerosol-generating device comprises a controller connected to the receiver.

EX6. An aerosol-generating device according to example EX5, the controller comprising a memory.

EX7. An aerosol-generating device according to example EX6, wherein, stored in the memory of the controller is data relating known measurements of electromagnetic radiation at specific wavelengths to chemical structures of, or types of, aerosol-forming substrates.

EX8. An aerosol-generating device according to example EX7, wherein the controller is configured to determine the type of aerosol-forming substrate received in the cavity by comparing one or more electromagnetic radiation measurements made by the sensor of the receiver at one or more wavelengths with the known measurements stored in the memory.

EX9. An aerosol-generating device according to any one of the preceding examples, wherein the emitter comprises at least one LED to emit the electromagnetic radiation.

EX10. An aerosol-generating device according to any one of the preceding examples, wherein the emitter is configured to emit a plurality of wavelengths of electromagnetic radiation.

EX11. An aerosol-generating device according to example EX10, wherein the emitter comprises a plurality of LEDs, each of the plurality of LEDs being configured to emit a different wavelength of electromagnetic radiation.

EX12. An aerosol-generating device according to any one of the preceding examples, wherein the sensor of the receiver comprises a photodiode.

EX13. An aerosol-generating device according to any one of the preceding examples, wherein the receiver is configured to receive a plurality of wavelengths of electromagnetic radiation.

EX14. An aerosol-generating device according to any one of the preceding examples, wherein the cavity comprises an opening at a first end for receiving the aerosol-forming substrate and is configured to receive the aerosol-forming substrate along a longitudinal axis.

EX15. An aerosol-generating device according to example EX14, wherein the emitter and receiver are parallel to the longitudinal axis.

EX16. An aerosol-generating device according to example EX15, wherein the emitter is on top of the receiver.

EX17. An aerosol-generating device according to examples EX15 or EX16, wherein the cavity comprises a second end opposite the first end and wherein the emitter and receiver are positioned so as to emit and receive electromagnetic radiation to and from the second end of the cavity, respectively.

EX18. An aerosol-generating device according to example EX14, wherein the emitter and receiver are perpendicular to the longitudinal axis.

EX19. An aerosol-generating device according to example EX18, wherein the emitter and receiver are positioned so as to emit and receive electromagnetic radiation to and from the cavity perpendicularly to the longitudinal axis.

EX20. An aerosol-generating device according to any one of the preceding examples, wherein the sensing assembly further comprises a shield configured to block electromagnetic radiation.

EX21. An aerosol-generating device according to example EX20, wherein the shield is positioned externally to the cavity and positioned such that the receiver is between the shield and the cavity.

EX22. An aerosol-generating device according to example EX20 or EX21, wherein the shield comprises an electrically conductive material.

EX23. An aerosol-generating device according to example EX22, wherein the electrically conductive material has an electrical conductivity of at least 1×10⁶ Siemens per metre, preferably at least 1×10⁷ Siemens per metre, even more preferably at least 5×10⁷ Siemens per metre.

EX24. An aerosol-generating device according to any one of examples EX20 to EX23, wherein the shield comprises a thermally conductive material.

EX25. An aerosol-generating device according to any one of examples EX20 to EX24, wherein the shield is configured to prevent the receiver from exceeding 115 degrees Celsius during use of the aerosol-generating device.

EX26. An aerosol-generating device according to any one of examples EX20 to EX25, wherein the thermally conductive material has a thermal conductivity of at least 10 Watts per metre-Kelvin, preferably at least 80 Watts per metre-Kelvin, preferably at least 100 Watts per metre-Kelvin, even more preferably at least 150 Watts per metre-Kelvin.

EX27. An aerosol-generating device according to any one of examples EX20 to EX26, wherein the shield comprises a metal.

EX28. An aerosol-generating device according to any one of examples EX20 to EX27 wherein at least a first portion of the shield is planar.

EX29. An aerosol-generating device according to example EX28, wherein the receiver is positioned between the first portion of the shield and the cavity.

EX30. An aerosol-generating device according to example EX29, wherein both the receiver and the emitter are positioned between the first portion of the shield and the cavity.

EX31. An aerosol-generating device according to example EX28 or EX29, wherein a second portion of the shield is planar.

EX32. An aerosol-generating device according example EX31, wherein the first and second portions of the shield are non-co-planar in a plane that is different to the plane of the first portion.

EX33. An aerosol-generating device according to example EX31 or EX32, wherein the receiver is positioned between the first portion of the shield and the cavity and the emitter is positioned between the second portion of the shield and the cavity.

EX34. An aerosol-generating device according to any one of examples EX31 to EX33, wherein the angle between the normal of the plane of the first portion and the normal of the plane of the second portion is substantially the same as the angle between the receiver and the emitter.

EX35. An aerosol-generating device according to any one of examples EX20 to EX34, wherein the sensing assembly further comprises a substrate, the substrate comprising a first side onto which at least one of the emitter and the receiver are attached.

EX36. An aerosol-generating device according to example EX35, wherein the substrate comprises a second side, opposite the first side, onto which the shield is attached.

EX37. An aerosol-generating device according to example EX35 or EX36 wherein the substrate comprises or consists of a Printed Circuit Board (PCB).

EX38. An aerosol-generating device according to any one of examples EX35 to EX37, wherein the shield comprises at least one clip.

EX39. An aerosol-generating device according example EX38, wherein the shield comprises a first clip at a first end and a second clip at a second end, the first end being at an opposite end of the shield to the second end.

EX40. An aerosol-generating device according to example EX39, wherein the one or more clips is configured to connect the clip to the second side of the substrate.

EX41. An aerosol-generating device according to any one of examples EX20 to EX40, wherein the shield is integrally formed.

EX42. An aerosol-generating device according to any one of examples EX20 to EX41, wherein the angle between the receiver and the emitter is between 20 and 120 degrees, preferably between 60 and 100 degrees, even more preferably 70 and 90 degrees, most preferably about 80 degrees.

EX43. An aerosol-generating device according to any one of the preceding examples, wherein the sensor assembly further comprises a lens.

EX44. An aerosol-generating device according to example EX43, wherein the lens is configured to focus electromagnetic radiation received from the cavity on to the sensor of the receiver.

EX45. An aerosol-generating device according to example EX44, wherein a surface area of the lens is at least ten times, preferably at least twenty times, even more preferably at least thirty times greater than the surface area of a part of the sensor of the receiver that is sensitive to electromagnetic radiation.

EX46. An aerosol-generating device according to any one of examples EX43 to EX45, wherein the lens comprises an absorption material.

EX47. An aerosol-generating device according to example EX46, wherein the absorption material is configured to substantially block wavelengths of electromagnetic radiation that fall outside a range of wavelengths.

EX48. An aerosol-generating device according to example EX47, wherein the absorption material is transparent to wavelengths of electromagnetic radiation that falls inside a range of wavelengths.

EX49. An aerosol-generating device according to any one of examples EX46 to EX48, wherein the absorption material is configured to substantially block wavelengths of electromagnetic radiation less than 200 nanometres, preferably less than 950 nanometres, even more preferably less than 1350 nanometres.

EX50. An aerosol-generating device according to any one of examples EX46 to EX49, wherein the absorption material is configured to substantially block electromagnetic radiation having a wavelength greater than 30,000 nanometres, preferably greater than 15,000 nanometres, preferably greater than 2000 nanometres, even more preferably greater than 1400 nanometres.

EX51. An aerosol-generating device according to any one of examples EX46 to EX50, wherein a main body of the lens comprises the absorption material.

EX52. An aerosol-generating device according to any one of examples EX46 to EX50, wherein the lens comprises the absorption material as a coating.

EX53. An aerosol-generating device according to any one of examples EX46 to EX51, wherein the absorption material comprises at least one of Cadmium Telluride, Chalcogenide Glass or Zinc Selenide.

EX54. An aerosol-generating device according to any one of the preceding examples, wherein the sensing assembly further comprises amplification electronics.

EX55. An aerosol-generating device according to example EX54, wherein the amplification electronics are connected to the receiver.

EX56. An aerosol-generating device according to example EX55, wherein the amplification electronics are configured to amplify signals generated by the sensor of the receiver.

EX57. An aerosol-generating device according to any one of examples EX54 to EX56, wherein the amplification electronics are analogue amplification electronics.

EX58. An aerosol-generating device according to any one of examples EX54 to EX57, wherein the amplification electronics are connected directly to the receiver.

EX59. An aerosol-generating device according to any one of examples EX54 to EX58 wherein the sensing assembly comprises a printed circuit board comprising the receiver and the amplification electronics are provided as part of the same printed circuit board.

EX60. An aerosol-generating device according to any one of examples EX54 to EX59, wherein the amplification electronics and the receiver are provided as a single component.

EX61. An aerosol-generating device according to any one of the preceding examples, wherein a first portion of the housing defining the cavity is transparent to at least one wavelength of the electromagnetic radiation emitted by the emitter.

EX62. An aerosol-generating device according to example EX61, wherein the emitter is configured to emit the electromagnetic radiation into the cavity through the transparent portion.

EX63. An aerosol-generating device according to example EX61 or EX62, wherein the first portion of the housing separates the emitter from the cavity.

EX64. An aerosol-generating device according to any one of examples EX61 to EX63, wherein an airflow path is defined through the aerosol-generating device from an air inlet to an air outlet, the airflow path passing through the cavity, the emitter separated from air flowing through the airflow path by the transparent first portion of the housing.

EX65. An aerosol-generating device according to any one of examples EX61 to EX64, wherein a second portion of the housing defining the cavity is transparent to at least one wavelength of the electromagnetic radiation received by the receiver, the receiver being configured to receive the electromagnetic radiation from the cavity through the second transparent portion.

EX66. An aerosol-generating device according to any one of the preceding examples, wherein the sensing assembly further comprises a substrate having a first side onto which at least one of the emitter and receiver are attached.

EX67. An aerosol-generating device according to example EX66, wherein both the emitter and the receiver is attached to the first side.

EX68. An aerosol-generating device according to example EX66 or EX67, wherein the substrate comprises a flexible portion.

EX69. An aerosol-generating device according to example EX68, wherein the flexible portion is configured so that the emitter is moveable relative to the receiver by bending the flexible portion.

EX70. An aerosol-generating device according to example EX69, wherein the substrate is bent such that the emitter is adjacent a different portion of the cavity to the receiver and such that the angle between the emitter and receiver is between 20 degrees and 120 degrees, preferably between 60 and 100 degrees, even more preferably 70 and 90 degrees, most preferably about 80 degrees.

EX71. An aerosol-generating device according to any one examples EX66 to EX70, wherein the substrate comprises a first portion comprising the emitter and a second portion comprising the receiver.

EX72. An aerosol-generating device according to example EX71, wherein the substrate comprises a third portion between the first and second portion and at least the third portion is flexible such that the first portion is moveable relative to the second portion.

EX73. An aerosol-generating device according to any one of examples EX55 to EX72, wherein the substrate comprises one or more PCBs.

EX74. An aerosol-generating device according to example EX73, wherein the substrate consists of one or more flexible PCBs.

EX75. An aerosol-generating device according to any one of the preceding examples, further comprising a controller configured to receive signals from the receiver, wherein the controller is configured to determine material properties of the aerosol-forming substrate at least partially received in the cavity based on a measured intensity of the electromagnetic radiation received at the receiver.

EX76. An aerosol-generating device according to example EX75, wherein the controller is configured to perform spectral analysis of the measured intensity of the electromagnetic radiation to determine material properties of the aerosol-forming substrate.

EX77. An aerosol-generating device according to example EX76, wherein the controller is configured to determine the type of aerosol-forming substrate at least partially received in the cavity based on the determined material properties.

EX78. An aerosol-generating device according to example EX76 or EX77, wherein the material property determined by the controller is a chemical property of the aerosol-forming substrate.

EX79. An aerosol-generating device according to any one of examples EX76 to EX78, wherein the material property is the presence or amount of a chemical component of the aerosol-forming substrate.

EX80. An aerosol-generating device according to any one of examples EX76 to EX79, wherein the material property determined by the controller is the wetness or water content of the aerosol-forming substrate.

EX81. An aerosol-generating device according to example EX80, wherein the controller is configured to determine a value related to the water content of an aerosol-forming substrate received in the cavity based on the measured intensity of the electromagnetic radiation received at the receiver.

EX82. An aerosol-generating device according to example EX81, wherein the controller is configured to determine the type of aerosol-forming substrate received in the cavity based on the determined value related to water content.

EX83. An aerosol-generating device according to example EX82, wherein the device furthers comprise a heating assembly for heating the aerosol-forming substrate, the heating assembly being controller by the controller, the controller being configured to control the heating assembly according to a heating profile selected based on the determined type of aerosol-forming substrate.

EX84. An aerosol-generating device according to any one of examples EX81 to EX83, wherein the controller is configured to determine the value related to the water content of an aerosol-forming substrate received in the cavity repeatedly during use of the aerosol-generating device.

EX85. An aerosol-generating device according to example EX84, wherein the controller is configured to modify a heating profile based on changes in the determined water content of the aerosol-forming substrate.

EX86. An aerosol-generating device according to example EX84 or EX85, wherein the controller is configured to stop heating of the aerosol-forming substrate by the heater assembly if the value related to the water content of the aerosol-forming substrate falls below a predetermined value.

EX87. A sensing assembly for an aerosol-generating device for generating aerosol from an aerosol-forming substrate and comprising a housing defining a cavity for at least partially receiving the aerosol-forming substrate, the sensing assembly comprising:
an emitter for emitting electromagnetic radiation into the cavity of the aerosol-generating device;
a receiver for receiving electromagnetic radiation from the cavity of the aerosol-generating device, the receiver comprising a sensor configured to measure at least one wavelength of the received electromagnetic radiation; and
a shield external to the receiver such that receiver can be positioned between the shield and the cavity of the aerosol-device device, the shield being configured to absorb electromagnetic radiation.

Features described in relation to one example or embodiment may also be applicable to other examples and embodiments.

Examples will now be further described with reference to the figures in which:

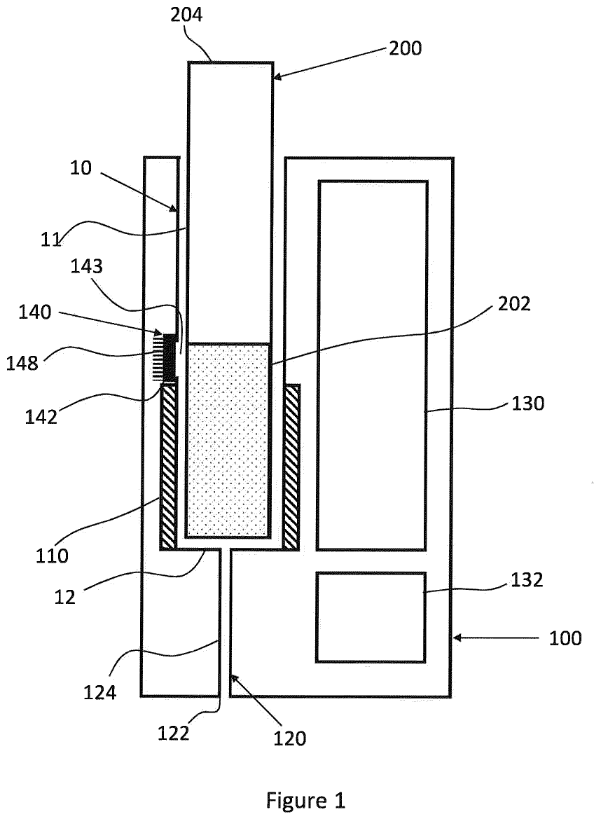

FIG. 1 is a schematic of a cross sectional view of a first aerosol-generating device;

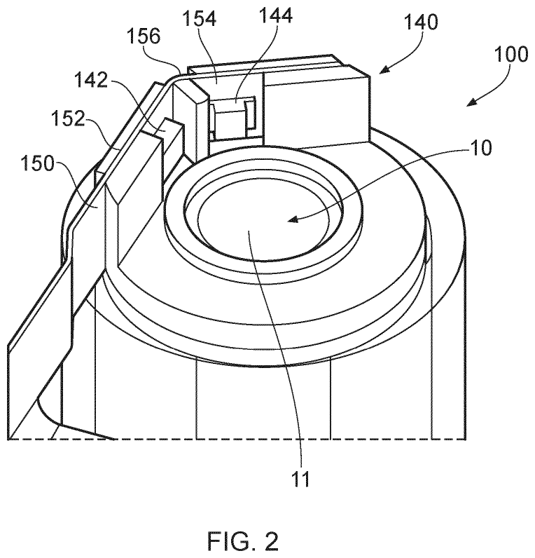

FIG. 2 is a perspective view of a cut away portion of the aerosol-generating device of FIG. 1 showing the sensing assembly of the aerosol-generating device;

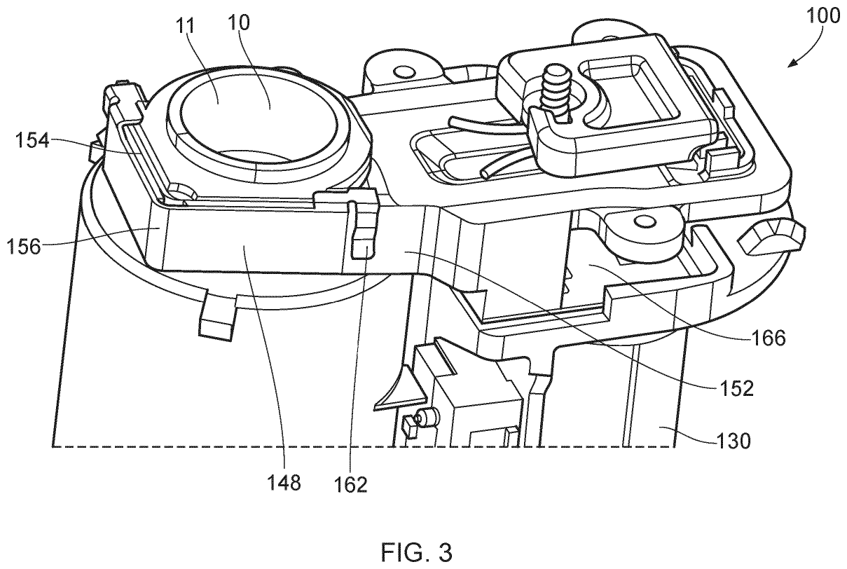

FIG. 3 is another perspective view of a cut away portion of the aerosol-generating device of FIG. 1 showing the sensing assembly from a different direction;

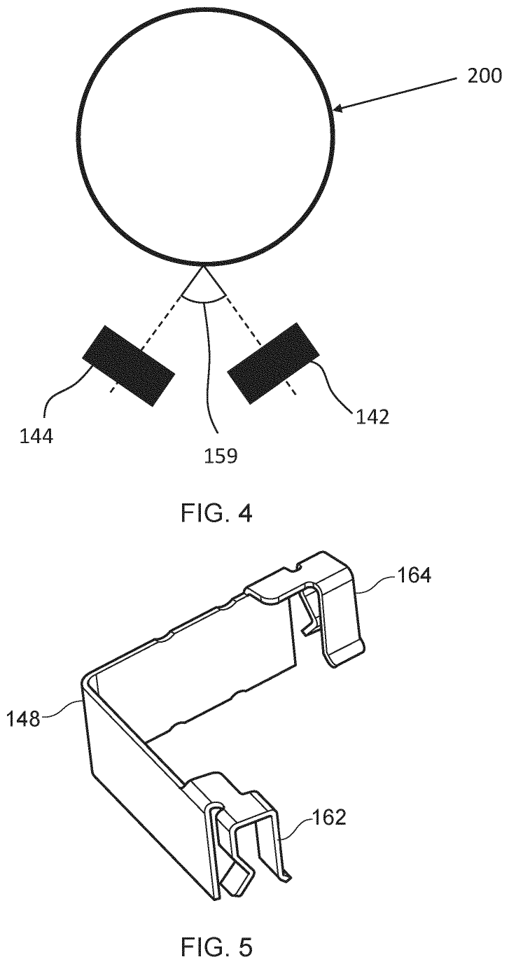

FIG. 4 shows a cross-section of an aerosol-generating article and an emitter and receiver of the sensing assembly of FIGS. 1 to 3;

FIG. 5 shows a perspective view of a clip of the sensing assembly shown separately from the rest of the aerosol-generating device;

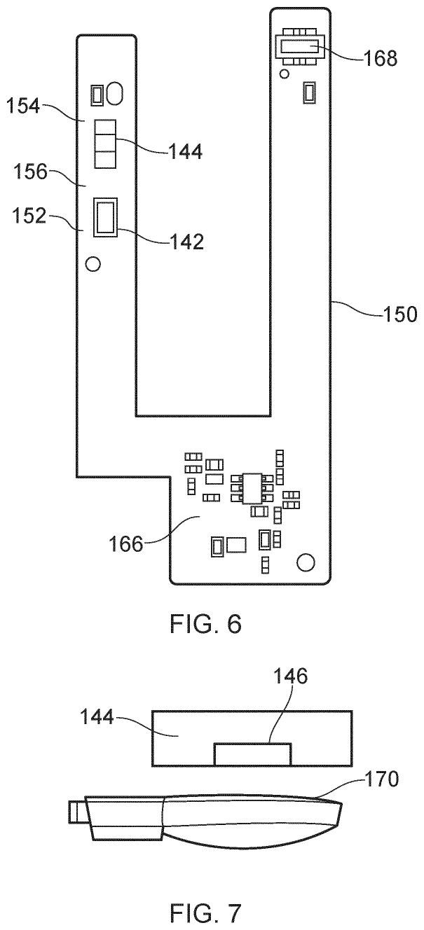

FIG. 6 shows a PCB of the sensing assembly separately from the rest of the aerosol-generating device and laid out flat;

FIG. 7 shows a lens of the sensing assembly; and

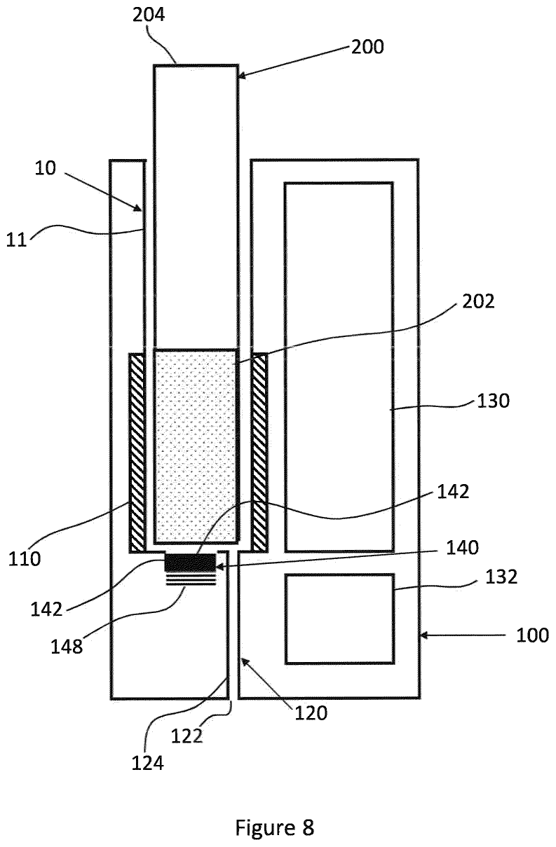

FIG. 8 shows a schematic of a cross sectional view of a second aerosol-generating device.

FIG. 1 is a schematic of a cross sectional view of a first aerosol-generating device 100. The aerosol-generating device 100 comprises a cavity 10 defined by a device housing 11. The cavity 10 is tubular and has at an upstream end a base 12. The cavity 10 is configured for receiving an aerosol-generating article 200.

An aerosol-generating article 200 is received in the cavity 10. The aerosol-generating article 200 contains an aerosol-forming substrate 202. The aerosol-forming substrate is a solid tobacco-containing substrate. In particular, the aerosol-forming substrate is a gathered sheet of homogenised tobacco. As shown in FIG. 1, the aerosol-generating article 200 and cavity 10 are configured such that a mouth end of the aerosol-generating article 200 protrudes out of the cavity 10 and out of the aerosol-generating device when the aerosol-generating article is received in the cavity 10. This mouth end forms a mouthpiece 204 on which a user of the aerosol-generating device may puff in use.

An aerosol-generating device 100 together with an aerosol-generating article 200 may be referred to as an aerosol-generating system.

The aerosol-generating device 100 comprises a heater assembly comprising a heating element 110. The heating element 110 surrounds the cavity 10 along a portion of the cavity in which the aerosol-forming substrate of the aerosol-generating article 200 is received. In an alternative embodiment, the heating element 110 forms a portion of the housing 11 that defines the part of the cavity that receives the aerosol-forming substrate. The heating element 110 is a resistive heating element.

An airflow channel 120 extends from an air inlet 122 of the aerosol-generating device 100. Upstream of the cavity, the airflow channel 120 is primarily defined by an airflow channel wall 124. Downstream of the airflow channel wall 124, the airflow channel 120 passes through an air inlet defined in the base 12 of the cavity. The airflow channel 120 then extends through the cavity 10. When an aerosol-generating article 200 is received in the cavity 10, the airflow channel 120 passes through the aerosol-generating article 200 and extends through the mouthpiece 204.

The aerosol-generating device 100 further comprises a power supply 130 in form of a rechargeable battery for powering the heating element 110 controllable by the controller 132. The power supply is connected to the controller and the heating element 110 via electrical wires and connections that are not shown in the Figures. The aerosol-generating device may comprise further elements, not shown in the Figures, such as a button for activating the aerosol-generating device.

The aerosol-generating device 100 further comprises a sensing assembly 140. The sensing assembly is shown more clearly in FIG. 2 which is a perspective view of the sensing assembly with a cut away portion of the aerosol-generating device.

The sensing assembly 140 comprises an emitter 142. The emitter comprises a plurality of LEDs. Each of the LEDs is configured to emit a different wavelength of electromagnetic radiation. The emitter 142, and in particular the plurality of LEDs of the emitter, is configured to emit the electromagnetic radiation into the cavity 10. The emitter 142 is configured to emit electromagnetic radiation having wavelengths of between 1350 and 1400 nanometres.

The cavity 10 comprises a first transparent portion 143. The emitter 142 is separated from the cavity 10 by the first transparent portion and is configured to emit electromagnetic radiation into the cavity through the transparent portion. The provision of the first transparent portion protects the emitter from debris and dirt that can accumulate in the cavity 10 after prolonged use of the device and can be easily cleaned.

The sensing assembly 140 further comprises a receiver 144. The receiver 144 is configured to receive electromagnetic radiation from the cavity. In particular, the receiver 144 is configured to receive electromagnetic radiation from the cavity that was emitted by the emitter 142 and then reflected or transmitted by the aerosol-generating article 200 towards the receiver. The receiver 144 comprises a sensor 146 (shown in FIG. 7) in the form of a photodiode. The sensor 146 is configured to measure a plurality of wavelengths of the received electromagnetic radiation. In particular, the sensor 146 is configured to measure the intensity of the plurality of wavelengths of received electromagnetic radiation. The receiver 144 is configured to receive electromagnetic radiation having wavelengths of between 1350 and 1400 nanometres.

The cavity 10 comprises a second transparent portion, not shown in the Figures. The receiver 144 is separated from the cavity 10 by the second transparent portion and is configured to receive electromagnetic radiation from the cavity 10 through the second transparent portion.

The sensing assembly 140 further comprises a shield 148. The shield 148 is not shown in FIG. 2 but is shown in FIG. 3, which shows another cut away perspective view of the aerosol-generating device 100 but looking towards the cavity from the opposite direction. The shield 148 is positioned externally to the cavity 10. Both the receiver 144 and the emitter 142 are positioned between the shield and the cavity and the shield is configured to block electromagnetic radiation. In this way, electromagnetic radiation that is external to the cavity 10 and sensing assembly 140 is blocked from reaching the emitter 142 and, more importantly, the receiver 144. This means that the amount of external electromagnetic radiation received at the receiver 144 is substantially reduced or eliminated and so is not detected as noise at the receiver.

The shield 148 is made of an aluminium which is electrically conductive and so reflects or absorbs the external electromagnetic radiation. Aluminium is also a thermally conductive material. The shield 148 being made of a thermally conductive material means that the shield is suitable for dissipating heat away from the receiver 144 and the emitter 142. As can be seen in FIG. 1, the sensing assembly 140 is positioned relatively close to the heating element 110. Thus, during use of the aerosol-generating device when current is passing through the heating element 110 such that it heats up, heat will inevitably be transferred from the heating element 110 to the sensing assembly 140. The emitter 142 and receiver 144 can be damaged when they are overheated. The shield 148 dissipating heat away from the emitter 142 and receiver 144 reduces the risk of the emitter 142 and receiver 144 being damaged.

The sensing assembly 140 further comprises a substrate in the form of a PCB 150. A first portion 152 of the PCB 150 comprises the emitter 142. A second portion 154 of the PCB 150 comprises the receiver 144. Both the first and second portions 152, 154 of the PCB are planar. The PCB 150 further comprises a third portion 156 which is flexible. As is shown most clearly in FIGS. 2 and 3, the third portion 156 has been bent such that the angle between the normal of the first portion 152 and the normal of the second portion 154 is 80 degrees. This also means that the angle between the central optical axis of the emitter 142 and the central optical axis of the receiver 144 is 80 degrees. This provides the optimum optical performance.

The third portion 156 is opaque to wavelengths of electromagnetic radiation emitted by the emitter 142. This ensures that electromagnetic radiation emitted by the emitter 142 is not directly received by the receiver 144.

The angle between the aerosol-generating article 200, the emitter 142 and the receiver 144 is shown most clearly in FIG. 4 which shows a cross-section of the aerosol-generating article 200 and the emitter 142 and receiver 144 separately from the rest of the device 10. The optimum angle between the central optical axis of the emitter 142 and the central optical axis of the receiver 144 is 80 degrees. The angle is represented by numeral 159 in FIG. 4.

FIG. 5 shows the shield 148 separately from the rest of the sensing assembly 140. As can be seen in FIG. 5, the shield 148 comprises two clips, a first clip 160 at a first end a second clip 162 at a second end. The clips are used to attach the shield 148 to the PCB 150. The shield is rigid enough that it is able to maintain and hold the first portion 152 of the PCB relative to the second portion 154 such that the angle between the normal of the first portion 152 and the normal of the second portion 154 is 80 degrees.

FIG. 6 shows the PCB 150 separately from the rest of the aerosol-generating device 100 and laid out flat. The PCB 150 of the sensing assembly 140 further comprises analogue amplification electronics 166 which are configured to amplify signals generated by the sensor of the receiver 144. The amplification electronics 166 are attached to a fourth portion of the PCB. By providing the amplification electronics 166 on the same PCB 150 as the receiver 144, there can be a direct electrical connection between the amplification electronics and the receiver 144. This minimizes the number of electrical connections between the amplification electronics 166 and the receiver 144 and so minimizes the amount of noise introduced to signals generated by the sensor 146 of the receiver 144 before those signals have been amplified.

The PCB 150 further comprises connector 168. The connector 168 is used to connect the PCB 150 to the electronics of the rest of aerosol-generating device 100, in particular the controller 132 and the power supply 130.

The flexible third portion 156 of the PCB 150 has already been described. The PCB 150 comprises further flexible portions which allow the PCB 150 to be folded into the shape shown in FIGS. 2 and 3.

FIG. 7 shows a lens 170 which is part of the sensing assembly 140 and which is not shown in FIGS. 1 to 6. The lens is positioned adjacent the receiver 144 and is configured to focus electromagnetic radiation received from the cavity 10 on to the sensor of the receiver. Because the surface area of the lens is much larger than the surface area of the sensor 146 of the receiver 144, the lens substantially increases the amount of electromagnetic radiation incident on the sensor 146.

The lens 170 comprises an absorption material. The absorption material acts as a band pass filter, absorbing electromagnetic radiation above and below certain wavelengths but allowing transmission of wavelengths in between. Such absorption materials are known and can be chosen to achieve a desired filter effect. In particular, the absorption materials can be chosen so that the transmission window includes the wavelengths of electromagnetic radiation emitted by the emitter 142 and received by the receiver 144 but filters out other wavelengths which would otherwise introduce noise to the signals detected by the sensor 146 of the receiver 144.

In some embodiments, the absorption material is applied to the surface of the lens as a coating. In other embodiments, the lens 170 itself is made of the absorption material.

In use of the aerosol-generating device 100, an aerosol-generating article 200 is received in the cavity 10, as shown in FIG. 1. The sensing assembly 140, in conjunction with the controller 132, is capable of detecting the presence of the aerosol-generating article 200. The emitter 142 of the sensing assembly 140 emits electromagnetic radiation at a plurality of wavelengths. This radiation is then reflected and/or transmitted by the aerosol-generating article 200. Because the viewing angles of the emitter 142 and receiver 144 substantially overlap when the angle between the central optical axis of the emitter and the central optical axis of the receiver is 80 degrees, a significant amount of the reflected and/or transmitted electromagnetic radiation is received by the sensor 146 of the receiver 144. The sensor 146 measures the intensity of the various wavelengths of received electromagnetic radiation. In doing so, the sensor 146 generates electrical signals. These electrical signals pass directly to the amplification electronics 166 to be amplified before being received at the controller 132. The controller 132 is configured to perform spectral analysis on the measurements of intensity of the electromagnetic radiation at different wavelengths. This comprises comparing the intensities of the different wavelengths of electromagnetic radiation with the known distribution of intensities emitted by the emitter 142. Based on the spectral analysis, the controller is configured to determine the presence of the aerosol-generating article 200.

The controller 132 is also configured to determine the type of aerosol-generating article 200 based on the spectral analysis. Different types of aerosol-generating article 200 can be received in the cavity 10. In particular, aerosol-generating articles having aerosol-forming substrate of differing chemistry can be received in the cavity 10. Because the aerosol-generating articles and aerosol-forming substrates have differing chemistry and/or other material properties, the different aerosol-generating articles 200 will reflect or transmit the plurality of wavelengths of electromagnetic radiation emitted by the emitter 142 to different extents. This will mean that the spectrum of electromagnetic radiation received by the receiver 144 will be different for different aerosol-generating articles 200. The spectrum for a particular type of aerosol-generating article is predictable. So, based on spectral analysis, the controller 132 can determine the type of aerosol-generating article 200 received in the cavity 10.

The controller 132 is configured to control the heating element according to an appropriate heating profile for the determined type of aerosol-generating article 200.

Based on this spectral analysis the controller is also configured to determine material properties of the aerosol-generating article received in the cavity 10. In particular, the controller 132 is configured to determine material properties of the aerosol-forming substrate of the aerosol-generating article 200. The material property determined by the controller is the wetness or water content of the aerosol-forming substrate.

The controller 132 is configured to determine a value related to the water content of an aerosol-forming substrate received in the cavity based on the measured intensity of the electromagnetic radiation received at the receiver. As explained above, the emitter 142 and receiver 144 are configured, respectively, to emit and receive wavelengths of electromagnetic radiation having wavelengths between 1350 nanometres and 1400 nanometres. Water is particularly effective at absorbing this range of electromagnetic radiation. Therefore, the intensity of radiation received by the receiver 144 is highly dependent on the water content of aerosol-forming substrate and the controller is able to determine a value associated with water content of the aerosol-forming substrate based on spectral analysis of electromagnetic radiation received by the receiver 144.

Different types of aerosol-forming substrate typically have a different water content to one another because of having differing amounts or types of aerosol former. The wetness or water content of the aerosol-forming substrate depends on the amount or type of aerosol former present in the aerosol-forming substrate. So, the controller 132 is configured to identify aerosol-forming substrates comprising different amounts or types of aerosol former based on the determined water content in the aerosol-forming substrate.

The water content of the aerosol-forming substrate will reduce over time. The reduction in water content can be as a result of at least one of heating of the aerosol-forming substrate by the aerosol-generating device in use, which depletes the aerosol-forming substrate, or as a result of the aerosol-forming substrate drying out in storage, particularly if the aerosol-forming substrate is stored incorrectly. The controller 132 is configured to repeatedly determine the value related to the water content of the aerosol-forming substrate during use of the device and between different use periods of the device. Therefore, changes in the water content of the aerosol-forming substrate can be detected by the controller 132. As the wetness of the aerosol-forming substrate changes, the controller 132 is configured to implement different heating profiles for heating the substrate. This ensures that a consistent amount of aerosol is generated during each puff despite the changes in wetness of the aerosol-forming substrate.

FIG. 8 is a schematic of a cross sectional view of a second aerosol-generating device 800. The aerosol-generating device 800 is similar to the first aerosol-generating device 100 and like features have been numbered accordingly. The second aerosol-generating device 800 also operates according to the same principal as the first aerosol-generating device 100. The main difference between the first aerosol-generating device 100 and the second aerosol-generating device 800 is the position of the sensing assembly. In the second aerosol-generating device 800, the sensing assembly 802 is positioned at the base 12 of the cavity 10, rather than in a sidewall of the cavity as in the first aerosol-generating device 100. The sensing assembly 802 is similar to the sensing assembly 140. For example, the sensing assembly 802 comprises an emitter, a receiver, a PCB, a lens and amplification electronics. However, the angle between the central optical axis of the emitter and the central optical axis of the receiver is different. In particular, the angle between the central optical axis of the emitter and the central optical axis of the receiver is 180 degrees and the emitter is positioned on top of the receiver. Furthermore, because the emitter is on top of the receiver, only a single transparent portion 804 in the housing is required. The emitter emits radiation into the cavity 10 through the transparent portion 804 and the receiver receives electromagnetic radiation from the cavity 10 through the transparent portion 804.

1.-13. (canceled)

14. An aerosol-generating device for generating aerosol from an aerosol-forming substrate, the aerosol-generating device comprising:
a housing defining a cavity configured to at least partially receive the aerosol-forming substrate; and
a sensing assembly comprising:
an emitter configured to emit electromagnetic radiation into the cavity,
a receiver configured to receive electromagnetic radiation from the cavity, the receiver comprising a sensor configured to measure at least one wavelength of the received electromagnetic radiation, and
a shield positioned externally to the cavity and such that the receiver is between the shield and the cavity, the shield being configured to block electromagnetic radiation,
wherein a first portion of the shield is planar and a second portion of the shield is planar, the first and the second portions of the shield being non-co-planar,
wherein an angle between a normal of a plane of the first portion and a normal of a plane of the second portion is substantially the same as an angle between the receiver and the emitter, and
wherein the receiver and the emitter are non-parallel.

15. The aerosol-generating device according to claim 14, wherein the shield comprises an electrically conductive material having an electrical conductivity of at least 1×10⁶ Siemens per meter.

16. The aerosol-generating device according to claim 14, wherein the shield comprises a thermally conductive material having a thermal conductivity of at least 10 Watts per meter-Kelvin.

17. The aerosol-generating device according to claim 14, wherein the angle between the receiver and the emitter is between 60 degrees and 100 degrees or about 0 degrees.

18. The aerosol-generating device according to claim 14, wherein the receiver is positioned between the first portion of the shield and the cavity, and the emitter is positioned between the second portion of the shield and the cavity.

19. The aerosol-generating device according to claim 14, further comprising at least one lens configured to focus electromagnetic radiation received from the cavity on to the sensor of the receiver, the at least one lens comprising an absorption material configured to substantially block wavelengths of electromagnetic radiation that fall outside a range of wavelengths.

20. The aerosol-generating device according to claim 19, wherein the absorption material is further configured to substantially block wavelengths of electromagnetic radiation less than 200 nanometers and greater than 30,000 nanometers.

21. The aerosol-generating device according to claim 14, wherein a first portion of the housing defining the cavity is transparent to at least some of the wavelengths of the electromagnetic radiation emitted by the emitter, and the emitter is further configured to emit the electromagnetic radiation into the cavity through the first portion of the housing that is transparent.

22. The aerosol-generating device according to claim 14,
wherein the sensing assembly further comprises a substrate having a first side onto which the emitter and the receiver are attached, a first portion of the substrate comprising the emitter, a second portion of substrate comprising the receiver,
wherein the substrate further comprises a third portion between the first and the second portions of the substrate, and
wherein at least the third portion is flexible such that the first portion of the substrate is moveable relative to the second portion of the substrate.

23. The aerosol-generating device according to claim 14, wherein the sensing assembly further comprises amplification electronics connected directly to the receiver.

24. The aerosol-generating device according to claim 14, further comprising a controller configured to receive signals from the receiver and to determine material properties of the aerosol-forming substrate at least partially received in the cavity, or an aerosol-generating article comprising the aerosol-forming substrate, based on a measured intensity of the electromagnetic radiation received at the receiver.

25. The aerosol-generating device according to claim 24, wherein a material property determined by the controller is wetness or water content of the aerosol-forming substrate.

26. A sensing assembly for an aerosol-generating device for generating aerosol from an aerosol-forming substrate, the aerosol-generating device comprising a housing defining a cavity configured to at least partially receive the aerosol-forming substrate, the sensing assembly comprising:
an emitter configured to emit electromagnetic radiation into the cavity of the aerosol-generating device;
a receiver configured to receive electromagnetic radiation from the cavity of the aerosol-generating device, the receiver comprising a sensor configured to measure at least one wavelength of the received electromagnetic radiation; and
a shield external to the receiver such that the shield prevents external electromagnetic radiation from passing through to the receiver, the shield being configured to absorb electromagnetic radiation,
wherein a first portion of the shield is planar and a second portion of the shield is planar, the first and the second portions of the shield being non-co-planar,
wherein an angle between a normal of a plane of the first portion and a normal of a plane of the second portion is substantially the same as an angle between the receiver and the emitter, and
wherein the receiver and the emitter are non-parallel.
